(19) United States
(12) Patent Application Publication
(10) Pub. No.: US 2002/0197987 A1
(43) Pub. Date: Dec. 26, 2002

(54) Transparent data transmission for wireless/cellular communication system

(76) Inventors: D. Cameron Taylor, Calgary (CA); Kenneth E. Scott, Calgary (CA); Andrew M. Sendyk, Calgary (CA)

Correspondence Address: CESARI AND MCKENNA, LLP, 88 BLACK FALCON AVENUE, BOSTON, MA, 02210, US

(21) Appl. No.: 09/891,140

(22) Filed: Jun. 25, 2001

(51) Int. Cl. H04Q 7/20

(52) U.S. Cl. 455/422; 455/403

(57) ABSTRACT

The output of an analog modem (12) at a remote cellular station (14) is converted to a digital signal in accordance with G.711 compaction before being applied to a processing chain (36) that results in wireless transmission to a cellular-telephone base station (24). Together with a signal chain (50) at the base station, the remote station's processing chain forms a transparent channel whose output is applied directly to a digital land-line span of the public switched telephone network. Because the G.711 encoding is the same as that conventionally employed for voice communication over a PSTN digital span, the modem's performance is the same in the absence of link errors as that which would result from conventional coupling directly to a PSTN digital link.

### BACKGROUND OF THE INVENTION

### FIELD OF THE INVENTION

The present invention is directed to wireless communication. It has particular, but not exclusive, application to facsimile and data transmission in cellular telephone networks.

### BACKGROUND INFORMATION

Cellular telephone networks can be employed not only for making voice telephone calls but also for other purposes, such as fax and data communications. Unfortunately, the common practice of using a dial-up modem—i.e., a modulator/demodulator of a type developed for use in the land-line telephone network—to send data between computers or fax machines through a voice network does not work well in typical cellular-telephone networks. This is because dial-up modems have been highly optimized for transmitting computer signals over voice networks. When the same types of modems are instead employed with remote cellular stations, the results have tended not to be as good. But departure from the voice-line-type modem is often inconvenient and costly.

### SUMMARY OF THE INVENTION

We have recognized that modems and similar equipment optimized for normal land-line communications can be readily used in cellular communications without detracting from their performance if the encoding employed for normal digital land-line transmission is performed at the remote station to which the modem or similar equipment is attached.

Specifically, the analog signal from a modem or other source is converted at the remote station to a digital bit stream in accordance with a memoryless compaction rule. The resultant bit stream is then transmitted through a transparent channel that includes a wireless cellular-telephone link. At the base station, that bit stream is transmitted over a public-switched-network span.

Typically, the memoryless compaction rule will be one of the rules of the International Telecommunications Union's Telecommunication Standardization Sector (“ITU-T”) Standard G.711, which is normally employed for digital voice transmission over the public switched telephone network (“PSTN”). For transmission from the base station to the remote station, the G.711 decoding is performed at the remote station to generate the output analog signal applied to the modem or other terminal equipment. From the point of view of the modem or other terminal equipment, therefore, the channel characteristics are just as they would be for an ordinary digital-land-line transmission, for which the terminal equipment has been optimized.

### BRIEF DESCRIPTION OF THE DRAWINGS

The invention description below refers to the accompanying drawings, of which:

FIG. 1 is a block diagram of a communications system in which the present invention's teachings may be practiced;

FIG. 2 is a more-detailed block diagram of the system's remote station; and

FIG. 3 is a more-detailed block diagram of the system's base system.

### DETAILED DESCRIPTION OF AN ILLUSTRATIVE EMBODIMENT

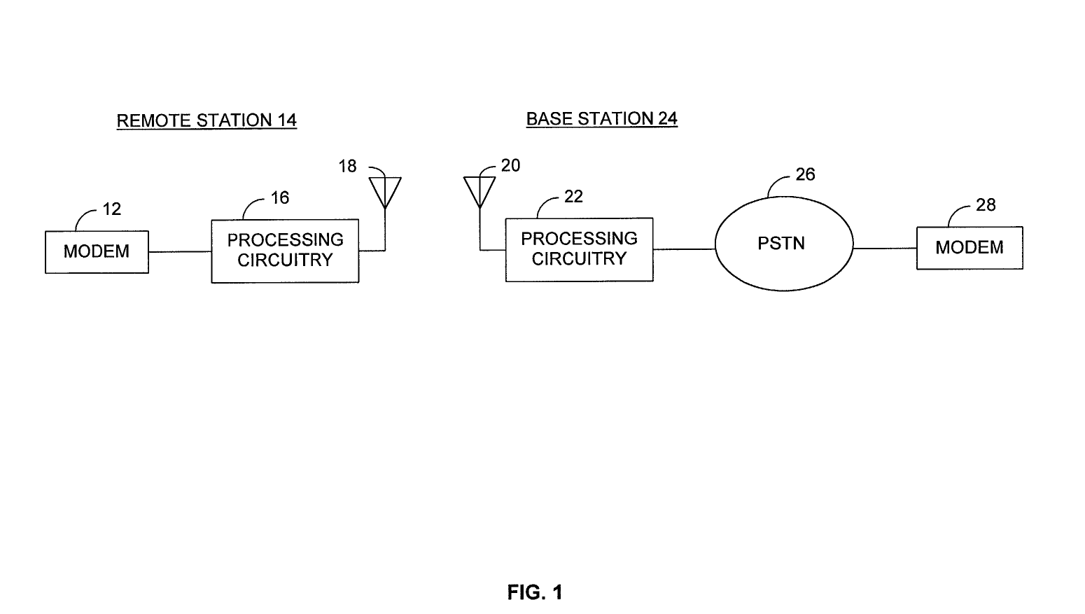

FIG. 1 depicts an exemplary communications system of the type in which the present invention's teachings can be employed. A modem 12 in a remote station 14 receives digital input, typically from a personal computer (not shown), and produces a frequency-shift-keyed analog signal representing the received digital data. The modem 12 applies its output to the remote station 14's processing circuitry 16, which performs processing to be described below before transmitting the results wirelessly from a remote-station antenna 18 through a cellular-telephone link to a base-station antenna 20. Further processing circuitry 22 in a base station 24 receives the signal from antenna 20 and processes it, applying its output to a digital span of the public switched telephone network 26. Network 26 ultimately converts the signal it receives to a frequency-shift-keying signal that a further modem 28 receives and converts to digital signals that it applies to, say, an Internet-service-provider server or another fax machine, also not shown. In a typical embodiment, the communications will be bi-directional: signals will also travel in the reverse direction, from modem 28 to modem 12.

As was mentioned above, the arrangement of FIG. 1 is merely exemplary. It will become apparent as the description proceeds that the present invention's teachings are not limited to modem-to-modem communications.

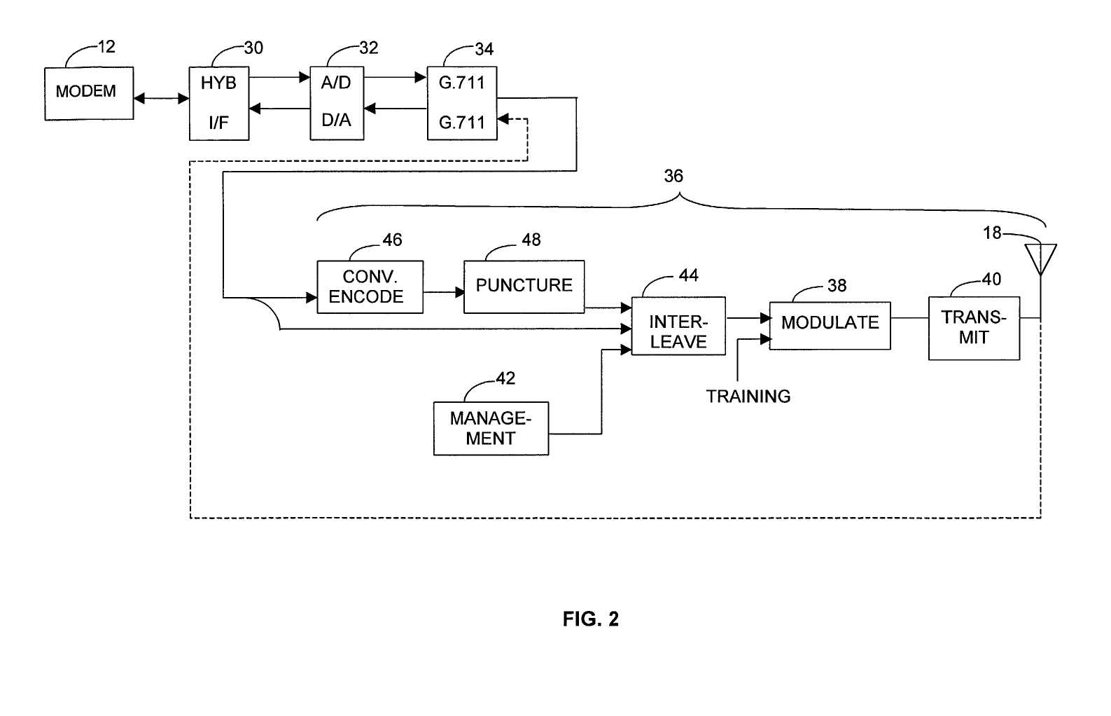

FIG. 2 depicts the remote station 14's processing circuitry in more detail. It depicts the typically two-wire bi-directional port of remote station 14's modem 12 as being coupled by a hybrid interface 30 to separate input and output ports of analog-to-digital/digital-to-analog circuitry 32. Although the illustrated embodiment is intended for bi-directional operation, we will initially consider only the remote station's transmission, not its reception, so the signal processing will be described only as proceeding from left to right in the drawings.

The analog-to-digital converter 32 treats the modem 12's output as an analog signal, taking samples and generating digital output signals to represent them. For the sake of explanation, we will assume that the analog-to-digital conversion occurs linearly and that the resultant digital signal is then separately compacted, in a step that block 34 represents, in accordance with one of the G.711 rules. But some speed improvement and potential equipment-cost reduction may occur if those steps are performed together, i.e., if the analog-to-digital conversion is performed in accordance with the G.711 scheme rather than linearly. Without regard to which approach is taken, we refer to any apparatus that thus produces a compacted digital representation from an input analog signal as an “analog-to-digital compactor.” As was observed above, the remote station typically also includes provision for receiving signals, not just transmitting them, and we will refer to any apparatus for performing the necessary reverse operation upon reception as a “digital-to-analog expander.”

As those skilled in the art recognize, G.711 rules specify memoryless conversion in accordance with which the quantization intervals increase with input magnitude so as to result in a greater dynamic range than would otherwise be the case. Although the present invention's teachings can be implemented with a non-G.711-specified memoryless-compaction type, the G.711 standards are the ones employed in encoding voice information for transmission over digital PSTN spans. The significance of this choice will become apparent in due course.

The output of the G.711 processing 34 is a bit stream that is applied to a signal-transmission chain 36. As will be explained in more detail below, the processing chain cooperates with corresponding circuitry at the base station to form a transparent channel. The precise nature of that chain's constituent elements is not critical to the present invention. For the sake of example, though, the drawings depict the illustrative embodiment as including processing, to be described directly, that results in application of digital data to a modulator 38 with whose output a transmitter 40 drives antenna 18. The modulation scheme in the example is a rectangular 16QAM scheme with a symbol rate of 24,300 symbols per second, the rate that is commonly employed in TIA/EIA-136-A-system digital channels. A root-raised-cosine filter having an excess bandwidth of thirty-five percent is applied to the rectangular-wave digital input before modulation of the in-phase and quadrature signal components.

A known thirty-six-symbol synchronization-and-training sequence occurring every forty milliseconds in the resultant output defines frames, and each frame in turn is divided, for reasons shortly to be apparent, into eight 117-symbol subframes. The training pattern is used to train an adaptive equalizer used in the receiver's demodulator to combat frequency-selective fading that can cause intersymbol interference detrimental to quality reception.

A source 42 of channel- and link-management information generates 160 bits of management information. An operation represented by block 44 divides this information among eight consecutive subframes and interleaves it with some user-data bits of G.711 encoder 34's output and with the output of encoding and puncturing operations 46 and 48 performed on other output bits from that encoder.

More specifically, the convolutional encoder 46 produces for each subframe a respective 560-bit output code words from a forty-octet sequence of the G.711 encoder's output by applying a 2:1 coding scheme to the 280-bit sequence that results from taking only the seven most-significant bits of each octet. Together with the training and management bits and the unencoded least-significant bits of the input octets, this would result in too great a bit rate for the physical channel, so the encoder's output is “punctured” in an operation that block 48 represents. That is, predetermined bits of each output code word are removed.

Block 44 represents not only interleaving the management information with the encoded user information but also so re-ordering the bits in the interleaved stream that consecutive bits in the code word tend to be spaced apart in the interleaving operation's output. This reduces the effects of burst errors in the wireless channel: when the base station that receives the wirelessly transmitted signal performs a complementary interleaving operation, burst errors in the received wireless signals will be less likely to result in burst errors in the signal to be decoded.

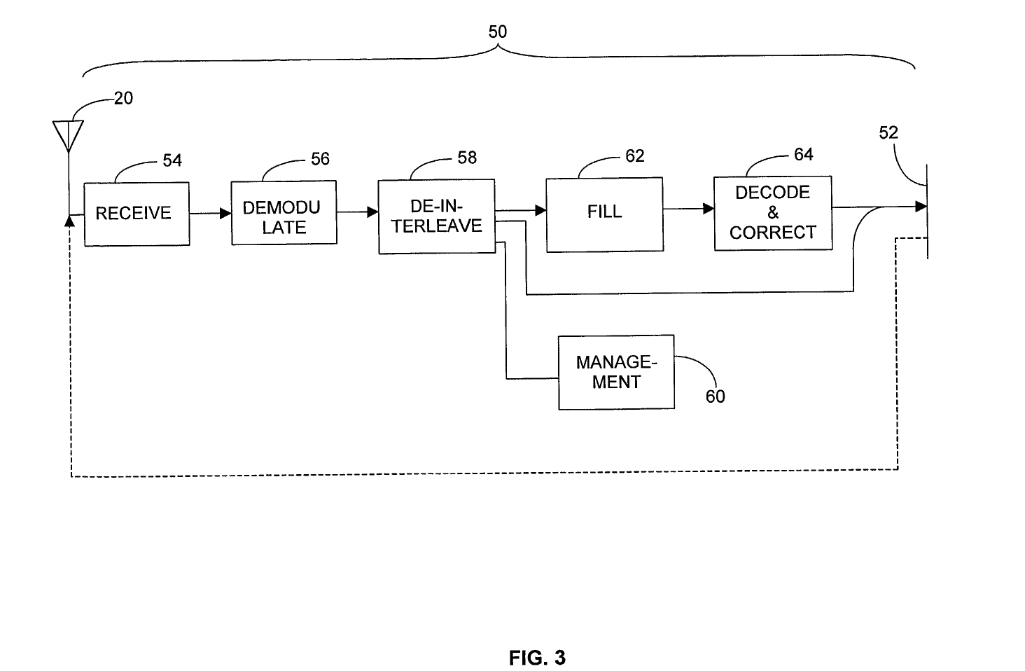

As will now be explained by reference to FIG. 3, a processing chain 50 in the base station forms a transparent channel with FIG. 2's processing chain 36 and the intervening wireless link. Absent unrecoverable errors, that is, the bit stream applied by FIG. 3's processing chain 50 to the digital-network interface 52 by which that bit stream is inserted into a digital PSTN channel is identical to the output of FIG. 2's G.711 encoding operation 34.

Specifically, a receiver 54 and demodulator 56 operate complementarily to FIG. 2's transmitter 40 and modulator 38, respectively, and a de-interleaving operation 58 so reorders the bit stream as to reverse the operation that FIG. 2's block 44 represents. The management information is then stripped out and sent to appropriate management operations 60, and the punctured code words are (at least conceptually) delivered to a fill operation 62, in which values are inserted into the predetermined locations from which bits were removed in FIG. 2's puncturing operation 48. This reconstitutes the punctured words into sequences of the proper code-word size, from which a decoding-and-correcting operation 64 will be able to recover the input that was applied to FIG. 2's convolutional encoder 46, i.e., to recover the G.711 encoder 34's output. So the signal that FIG. 3's decoding-and-correction operation 64 applies to the digital network interface 52 is the same as the G.711 encoder output: it is as though the G.711 output were being applied directly to the interface. So the modem 12's performance is the same as it would have been in the environment for which it was designed.

Although the drawings show FIG. 2's processing circuitry 36 only in the remote station and show FIG. 3's processing circuitry 50 only in the base station, those drawings' dashed lines are intended to represent the above-mentioned fact that the typical embodiment will be bi-directional: the remote station will usually also perform operations similar to those illustrated for the base station, while the base station usually will also perform operations similar to those illustrated for the remote station.

Those skilled in the art will recognize that a typical implementation will employ a common digital signal processor to perform many of the remote station's functions, and the base station, too, will typically employ its own common digital signal processor to perform its functions. In particular, FIG. 2's encoding, puncturing, and interleaving operations 46, 48, and 44, possibly together with the pre-modulation filtering implied in the modulation block 38, can be implemented in a single digital signal processor. The G.711 coding and decoding can, too, if those functions are not performed integrally with the conversions between digital and analog. The same processor can also perform the complementary operations required for reception.

Moreover, the same radio-frequency circuitry and digital signal processor can be used in processing other channels. In particular, a parallel, control channel may be used to receive or transmit information that identifies the illustrated channel as being of the type in which the illustrated processing is to be performed. That is, the digital signal processor can be so programmed as to alternate between the illustrated type of processing, which may be referred to as, for instance, “High-Order Modulation Traffic Channel Type A” (“HTC-A”), and conventional DCT (Digital Traffic Channel), AVC (Analog Voice Channel), ACCH (Analog Control Channel), and DCCH (Digital Control Channel) processing. Selection among the various processing types would typically be determined by the control channel's contents. That control channel is preferably a standard TIA/EIA-136-A channel, and selection among the processing types would be made in accordance with the service code that the control channel passes. Specifically, that selection would be made in one of the service-code fields currently reserved for expansion

From the foregoing description, it is apparent that a communications system employing the present invention's teachings can employ modems and other terminal equipment so designed as to be optimized for conventional land-line digital spans without degradation when used in cellular or other wireless transmission. The present invention thus constitutes a significant advance in the art.

What is claimed is:

1. For wireless communication, a method comprising:
A) taking remote-source samples of a remote-source analog signal at a remote station and converting the remote-source samples to a remote-source bit stream at the remote station in accordance with a memoryless compaction rule;
B) from the remote station, transmitting the remote-source bit stream to a base station through a transparent remote-to-base channel that includes a cellular-telephone link;
C) at the base station, receiving the remote-source bit stream from the transparent remote-to-base channel; and
D) applying the remote-source bit stream at the base station to a digital public-switched-telephone-network span.

2. A method as defined in claim 1 wherein the memoryless-compaction rule is one of the ITU-T G.711 rules.

3. A method as defined in claim 1 wherein the transparent remote-to-base channel employs complementary error-correction coding and decoding.

4. A method as defined in claim 3 wherein the memoryless-compaction rule is one of the ITU-T G.711 rules.

5. A method as defined in claim 3 wherein the error-correction coding employed in the transparent remote-to-base channel is punctured.

6. A method as defined in claim 3 wherein not all bits of the remote-source bit stream are included in the error-correction coding and decoding employed in the transparent remote-to-base channel.

7. A method as defined in claim 6 wherein all but the least-significant bits of the remote-source bit stream are included in the error-correction coding and decoding employed in the transparent remote-to-base channel.

8. A method as defined in claim 7 wherein the error-correction coding employed in the transparent remote-to-base channel is punctured.

9. A method as defined in claim 1 further including:
A) receiving a network-source bit stream at the base station from the digital public-switched-telephone-network span;
B) from the base station, transmitting the remote-source bit stream to the remote station through a transparent base-to-remote channel that includes the cellular-telephone link;
C) at the base station, receiving the network-source bit stream from the transparent base-to-remote channel; and
D) converting the network-source bit stream to a network-source analog signal at the remote station in accordance with a memoryless-expansion rule.

10. A method as defined in claim 9 wherein the memoryless-expansion rule is one of the ITU-T G.711 rules.

11. A method as defined in claim 10 wherein the memoryless-compaction rule is one of the ITU-T G.711 rules.

12. A method as defined in claim 9 wherein the transparent base-to-remote channel employs complementary error-correction coding and decoding.

13. A method as defined in claim 12 wherein the memoryless-expansion rule is one of the ITU-T G.711 rules.

14. A method as defined in claim 13 wherein the memoryless-compaction rule is one of the ITU-T G.711 rules.

15. A method as defined in claim 12 wherein the error-correction coding employed in the transparent base-to-remote channel is punctured.

16. A method as defined in claim 12 wherein not all bits of the network-source bit stream are included in the error-correction coding and decoding employed in the transparent base-to-remote channel.

17. A method as defined in claim 16 wherein all but the least-significant bits of the network-source bit stream are included in the error-correction coding and decoding employed in the transparent base-to-remote channel.

18. A method as defined in claim 12 wherein the transparent remote-to-base channel employs complementary error-correction coding and decoding.

19. A method as defined in claim 18 wherein the error-correction coding employed in the transparent base-to-remote channel is punctured.

20. A method as defined in claim 19 wherein the error-correction coding employed in the transparent remote-to-base channel is punctured.

21. A communications system that includes:
A) a remote station including:
i) a remote-station remote-to-base processing chain coupled to receive a remote-source bit stream and transmit into a wireless cellular-telephone link a remote-to-base wireless signal derived therefrom; and
ii) an analog-to-digital compactor connected to receive an analog input and apply to the remote-station processing chain as the remote-source bit stream a digital signal that represents the analog input in accordance with a memoryless-compaction rule; and
B) a base station including:
i) a land-line interface connected to apply to a digital public-switched-telephone-network span a bit stream applied to the land-line interface; and
ii) a base-station remote-to-base processing chain wirelessly coupled to receive the remote-to-base wireless signal from the wireless cellular-telephone link and form with the remote-station remote-to-base processing chain and the wireless cellular-telephone link a transparent remote-to-base channel that applies the remote-source bit stream to the land-line interface as the input thereof.

22. A communications system as defined in claim 21 wherein the memoryless-compaction rule is one of the ITU-T G.711 rules.

23. A communications system as defined in claim 21 wherein the transparent remote-to-base channel employs complementary error-correction coding and decoding.

24. A communications system as defined in claim 23 wherein the memoryless-compaction rule is one of the ITU-T G.711 rules.

25. A communications system as defined in claim 23 wherein the error-correction coding employed in the transparent remote-to-base channel is punctured.

26. A communications system as defined in claim 23 wherein not all bits of the network-source bit stream are included in the error-correction coding and decoding employed in the transparent base-to-remote channel.

27. A communications system as defined in claim 26 wherein all but the least-significant bits of the remote-source bit stream are included in the error-correction coding and decoding employed in the transparent remote-to-base channel.

28. A communications system as defined in claim 27 wherein the error-correction coding employed in the transparent remote-to-base channel is punctured.

29. A communications system as defined in claim 21 further wherein:
A) the base station further includes a base-station base-to-remote processing chain coupled to the land-line interface to receive a network-source bit stream and transmit into a wireless cellular-telephone link a wireless signal derived therefrom; and
B) the remote station further includes:
i) a digital-to-analog expander connected to receive a digital input and produce as an expander output a signal that represents the digital input in accordance with a memoryless-expansion rule; and
ii) a remote-station base-to-remote processing chain wirelessly coupled to receive the base-to-remote wireless signal from the wireless cellular-telephone link and form with the base-station base-to-remote processing chain a transparent base-to-remote channel that applies the network-source bit stream to the digital-to-analog expander as the input thereof.

30. A communications system as defined in claim 29 wherein the memoryless-expansion rule is one of the ITU-T G.711 rules.

31. A communications system as defined in claim 30 wherein the memoryless-compaction rule is one of the ITU-T G.711 rules.

32. A communications system as defined in claim 29 wherein the transparent base-to-remote channel employs complementary error-correction coding and decoding.

33. A communications system as defined in claim 32 wherein the memoryless-expansion rule is one of the ITU-T G.711 rules.

34. A communications system as defined in claim 33 wherein the memoryless-compaction rule is one of the ITU-T G.711 rules.

35. A communications system as defined in claim 32 wherein the error-correction coding employed in the transparent base-to-remote channel is punctured.

36. A communications system as defined in claim 32 wherein not all bits of the network-source bit stream are included in the error-correction coding and decoding employed in the transparent base-to-remote channel.

37. A communications system as defined in claim 36 wherein all but the least-significant bits of the remote-source bit stream are included in the error-correction coding and decoding employed in the transparent remote-to-base channel.

38. A communications system as defined in claim 32 wherein the transparent remote-to-base channel employs complementary error-correction coding and decoding.

39. A communications system as defined in claim 38 wherein the error-correction coding employed in the transparent base-to-remote channel is punctured.

40. A communications system as defined in claim 39 wherein the error-correction coding employed in the transparent remote-to-base channel is punctured.
